(19) United States
(12) Patent Application Publication
(10) Pub. No.: US 2017/0181924 A1
(43) Pub. Date: Jun. 29, 2017

(54) FACIAL MASSAGING MASK

(71) Applicant: HCT GROUP HOLDINGS LIMITED, Central (CN)

(72) Inventors: TIMOTHY THORPE, SANTA MONICA, CA (US); ARMANDO VILLARREAL, LOS ANGELES, CA (US); STEPHEN CHEN, LOS ANGELES, CA (US)

(73) Assignee: HCT GROUP HOLDINGS LIMITED, Central (CN)

(21) Appl. No.: 15/391,557

(22) Filed: Dec. 27, 2016

Related U.S. Application Data
(60) Provisional application No. 62/272,322, filed on Dec. 29, 2015.

(51) Int. Cl. A61H 23/02; A61H 7/00

(52) U.S. Cl. CPC A61H 23/02; A61H 7/001; A61H 7/002; A61H 2201/0207; A61H 2201/0214; A61H 2201/0242; A61H 2205/022

(57) ABSTRACT

A facial massage device configured to be positioned on a human face may include a plurality of layers. An intermediate portion may be disposed between an outer cover and an inner liner. The intermediate portion may include a plurality of individually actuatable massage elements. In some cases, the individually actuatable massage elements may be pneumatically actuated. In other cases, the individually actuatable massage elements may be mechanically actuated. The facial massage device may further include a control module configured to actuate the plurality of individually actuatable massage elements.

### CROSS REFERENCE TO RELATED APPLICATIONS

The present application claims the benefit of and priority to U.S. Provisional Patent Application Ser. No. 62/272,322, filed Dec. 29, 2015, titled FACIAL MASSAGING MASK, the disclosure of which is incorporated herein by reference.

### TECHNICAL FIELD

The disclosure is directed to a massage device for a human face.

### SUMMARY

This disclosure provides design, material, manufacturing methods, and use alternatives for facial massage devices.

In a first example, a facial massage device may comprise an outer cover, an inner liner, and an intermediate pressure pouch disposed between the outer cover and the inner liner. The intermediate pressure pouch may include a plurality of individually actuatable compartments. A first fluid source may be fluidly coupled to the plurality of individually actuatable compartments and a control module may be in electrical communication with the first fluid source.

In another example, a facial massage device may comprise an outer cover, an inner liner, an intermediate portion disposed between the outer cover and the inner liner, The intermediate portion may include a plurality of individually actuatable massage elements. A control module may be configured to actuate the plurality of individually actuatable massage elements.

Alternatively or additionally to any of the examples above, in another example, the intermediate portion may comprise an intermediate pressure pouch and the individually actuatable massage element may comprise a plurality of individually actuatable compartments formed in the intermediate pressure pouch. The facial massage device may further comprise a first fluid source fluidly coupled to the plurality of individually actuatable compartments.

Alternatively or additionally to any of the examples above, in another example, the control module may be configured to inflate and/or deflate the plurality of individually actuatable compartments in a predefined order.

Alternatively or additionally to any of the examples above, in another example, the predefined order may be from a forehead area of the facial massage device to a chin area of the facial massage device.

Alternatively or additionally to any of the examples above, in another example, the predefined order may be from an inner area of the facial massage device to an outer area of the facial massage device.

Alternatively or additionally to any of the examples above, in another example, the predefined order may be from a first side of the facial massage device to a second side of facial massage device.

Alternatively or additionally to any of the examples above, in another example, the first fluid source may include a cooling mechanism for cooling a fluid before delivery to the individually actuatable compartments.

Alternatively or additionally to any of the examples above, in another example, the first fluid source may include a heating mechanism for heating a fluid before delivery to the individually actuatable compartments.

Alternatively or additionally to any of the examples above, in another example, the facial massage device may further comprise a second fluid source configured to deliver an ion mist adjacent to the inner liner.

Alternatively or additionally to any of the examples above, in another example, the facial massage device may further comprise a second fluid source configured to deliver steam adjacent to the inner liner.

Alternatively or additionally to any of the examples above, in another example, the intermediate pressure pouch may comprise two layers of polyurethane heat welded along a plurality of seams to define the plurality of individually actuatable compartments.

Alternatively or additionally to any of the examples above, in another example, the inner liner may comprise a gel material disposed within a membrane.

Alternatively or additionally to any of the examples above, in another example, the control module may be configured to operate a fluid delivery to the individually actuatable compartments in accordance with a user defined order.

Alternatively or additionally to any of the examples above, in another example, the intermediate portion may comprise an intermediate frame including an elongate bridge element and two or more arms extending laterally from the elongate bridge and the plurality of individually actuatable massage elements may comprise at least one massaging node positioned at an end of each of the two or more arms.

Alternatively or additionally to any of the examples above, in another example, the at least one massaging node may comprise a vibrating massage node.

Alternatively or additionally to any of the examples above, in another example, the at least one massaging node may comprise a rotating base having at least one generally spherical massaging element disposed thereon.

Alternatively or additionally to any of the examples above, in another example, the at least one massaging node may comprise a rotating cam.

Alternatively or additionally to any of the examples above, in another example, the inner liner may comprise a gel material disposed within a membrane.

In another example, a facial massage device may comprise an outer cover, an inner liner, and an intermediate pressure pouch disposed between the outer cover and the inner liner. The intermediate pressure pouch may comprise two layers of polyurethane heat welded along a plurality of seams to define a plurality of individually actuatable compartments. A first fluid source may be fluidly coupled to the plurality of individually actuatable compartments and a control module may be in electrical communication with the first fluid source, the control module configured to control a delivery of a fluid from the first fluid source to the plurality of individually actuatable compartments.

Alternatively or additionally to any of the examples above, in another example, the control module may control the delivery of the fluid from the first fluid source to the plurality of individually actuatable compartments in accordance with a user defined control algorithm.

Alternatively or additionally to any of the examples above, in another example, the control module may control the delivery of the fluid from the first fluid source to the plurality of individually actuatable compartments in accordance with a pre-programmed control algorithm.

Alternatively or additionally to any of the examples above, in another example, the first fluid source may include a cooling mechanism for cooling the fluid before delivery to the individually actuatable compartments.

Alternatively or additionally to any of the examples above, in another example, the first fluid source may include a heating mechanism for heating the fluid before delivery to the individually actuatable compartments.

Alternatively or additionally to any of the examples above, in another example, the plurality of individually actuatable compartments may include at least eight individually actuatable compartments.

In another example, a facial massage device may comprise an outer cover, an inner liner, and an intermediate pressure pouch disposed between the outer cover and the inner liner. The intermediate pressure pouch may comprise two layers of polyurethane heat welded along a plurality of seams to define a plurality of individually actuatable compartments. A first fluid source may be fluidly coupled to the plurality of individually actuatable compartments and a control module may be in electrical communication with the first fluid source. The control module may be configured to control a delivery of a fluid from the first fluid source to the plurality of individually actuatable compartments. A second fluid source may be configured to deliver moisture an inner surface of the facial massage device.

Alternatively or additionally to any of the examples above, in another example, the first fluid source may include a cooling mechanism for cooling the fluid and/or a heating mechanism for heating the fluid before delivery to the plurality of individually actuatable compartments.

In another example, a facial massage device may comprise an outer cover, an inner liner, and an intermediate frame disposed between the outer cover and the inner liner. The intermediate frame may include an elongate bridge element and one or more arms extending laterally from the elongate bridge. At least one massaging node may be positioned at an end of the one or more arms and a control module may be in electrical communication with the at least one massaging node.

Alternatively or additionally to any of the examples above, in another example, the at least one massaging node may comprise a vibrating massage node.

Alternatively or additionally to any of the examples above, in another example, the at least one massaging node may comprise a rotating base having at least one generally spherical massaging element disposed thereon.

Alternatively or additionally to any of the examples above, in another example, the at least one massaging node may comprise a rotating cam.

Alternatively or additionally to any of the examples above, in another example, the outer cover may comprise a rigid polymer.

Alternatively or additionally to any of the examples above, in another example, the inner liner may comprise a gel material disposed within a membrane.

Alternatively or additionally to any of the examples above, in another example, the outer cover and the inner liner may each comprise a plurality of apertures.

Alternatively or additionally to any of the examples above, in another example, the facial massage device may further comprise a strap configured to secure the device to a user's head.

Alternatively or additionally to any of the examples above, in another example, the one or more arms may comprise eight arms.

Alternatively or additionally to any of the examples above, in another example, the facial massage device may further comprise a cooling apparatus disposed within the control module and configured to deliver a cooling fluid.

Alternatively or additionally to any of the examples above, in another example, the facial massage device may further comprise a heating apparatus disposed within the control module and configured to deliver a heating fluid.

In another example, a facial massage device may comprise a mask configured to be positioned on a human face. The mask may comprise an outer cover, an inner liner, and an intermediate frame disposed between the outer cover and the inner liner. The intermediate frame may include an elongate bridge element and a plurality of arms extending laterally from the elongate bridge. The mask may further comprise a plurality of massaging nodes, wherein a massaging node is positioned at an end of each arm of the plurality of arms. The facial massage device may further include a control module in electrical communication with the plurality of massaging nodes.

Alternatively or additionally to any of the examples above, in another example, the plurality of massaging nodes may be individually controllable.

Alternatively or additionally to any of the examples above, in another example, the control module may include at least one actuatable element for controlling the power supply to the plurality of massaging modes.

Alternatively or additionally to any of the examples above, in another example, the plurality of massaging nodes may comprise vibrating massage nodes.

Alternatively or additionally to any of the examples above, in another example, the plurality of massaging nodes may each comprise a rotating base having at least one generally spherical massaging element disposed thereon.

Alternatively or additionally to any of the examples above, in another example, the plurality of massaging nodes may each comprise a rotating cam.

In another example, a facial massage device may comprise an outer cover comprising a rigid polymer, an inner liner comprising a gel-filled membrane, and an intermediate frame comprising a semi-rigid polymer disposed between the outer cover and the inner liner. The intermediate frame may include an elongate bridge element and at least six arms extending laterally from the elongate bridge. The facial massage device may further include a plurality of massaging nodes, wherein a massaging node is positioned at an end of each of the at least six arms. At least one massaging node may be positioned at an end of each of the one or more arms. A strap may be configured to releasably secure the facial massage device to a human face. A control module may be in electrical communication with the at least one massaging node.

Alternatively or additionally to any of the examples above, in another example, the plurality of massaging nodes may comprise vibrating massage nodes.

Alternatively or additionally to any of the examples above, in another example, the plurality of massaging nodes may each comprise a rotating base having at least one generally spherical massaging element disposed thereon.

Alternatively or additionally to any of the examples above, in another example, the plurality of massaging nodes may each comprise a rotating cam.

Alternatively or additionally to any of the examples above, in another example, the plurality of massaging nodes may comprise vibrating massage nodes, a rotating base having at least one generally spherical massaging element disposed thereon, a rotating cam, or combinations thereof.

In another example, a facial massage device may comprise an outer cover, an inner liner, at least one massaging node positioned between the outer cover and the inner liner, and a control module in electrical communication with the at least one massaging node.

Alternatively or additionally to any of the examples above, in another example, the at least one massaging node may comprise a vibrating massage node.

Alternatively or additionally to any of the examples above, in another example, the at least one massaging node may comprise a rotating base having at least one generally spherical massaging element disposed thereon.

Alternatively or additionally to any of the examples above, in another example, the at least one massaging node may comprise a rotating cam.

Alternatively or additionally to any of the examples above, in another example, the outer cover may comprise a rigid polymer.

Alternatively or additionally to any of the examples above, in another example, the inner liner may comprise a gel material disposed within a membrane.

Alternatively or additionally to any of the examples above, in another example, the outer cover and the inner liner may each comprise a plurality of apertures.

Alternatively or additionally to any of the examples above, in another example, the facial massage device may comprise a strap configured to secure the device to a user's head.

Alternatively or additionally to any of the examples above, in another example, the facial massage device may further comprise an intermediate frame comprising a semi-rigid polymer disposed between the outer cover and the inner liner.

Alternatively or additionally to any of the examples above, in another example, the at least one massage node may be affixed to the intermediate frame.

The above summary of some example embodiments is not intended to describe each disclosed embodiment or every implementation of the invention.

### BRIEF DESCRIPTION OF THE DRAWINGS

The invention may be more completely understood in consideration of the following detailed description of various embodiments in connection with the accompanying drawings, in which:

FIG. 1 is a perspective view of an illustrative facial massaging mask;

FIG. 2 is an exploded view of the illustrative facial massaging mask of FIG. 1;

FIG. 3 is an illustrative massage node for use with a facial massaging mask;

FIG. 4 is another illustrative massage node for use with a facial massaging mask;

FIG. 5 is another illustrative massage node for use with a facial massaging mask;

FIG. 6 is a perspective view of an illustrative facial massaging mask including the illustrative massage nodes of FIGS. 4 and 5;

FIG. 7 is another illustrative massage node for use with a facial massaging mask;

FIG. 8 is another illustrative massage node for use with a facial massaging mask;

FIG. 9 is another illustrative massage node for use with a facial massaging mask;

FIG. 10 is another illustrative massage node for use with a facial massaging mask;

FIG. 11 is another illustrative massage node for use with a facial massaging mask;

FIG. 12 is another illustrative massage node for use with a facial massaging mask; and

FIG. 13 is a perspective view of an illustrative facial massaging mask including the illustrative massage nodes of FIGS. 7-12;

FIG. 14 is a perspective view of another illustrative facial massaging mask;

FIG. 15 is an exploded view of the illustrative facial massaging mask of FIG. 14; and

FIG. 16 is a perspective view of a portion of the illustrative facial massaging mask of FIG. 14.

While the invention is amenable to various modifications and alternative forms, specifics thereof have been shown by way of example in the drawings and will be described in detail. It should be understood, however, that the intention is not to limit aspects of the invention to the particular embodiments described. On the contrary, the intention is to cover all modifications, equivalents, and alternatives falling within the spirit and scope of the invention.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

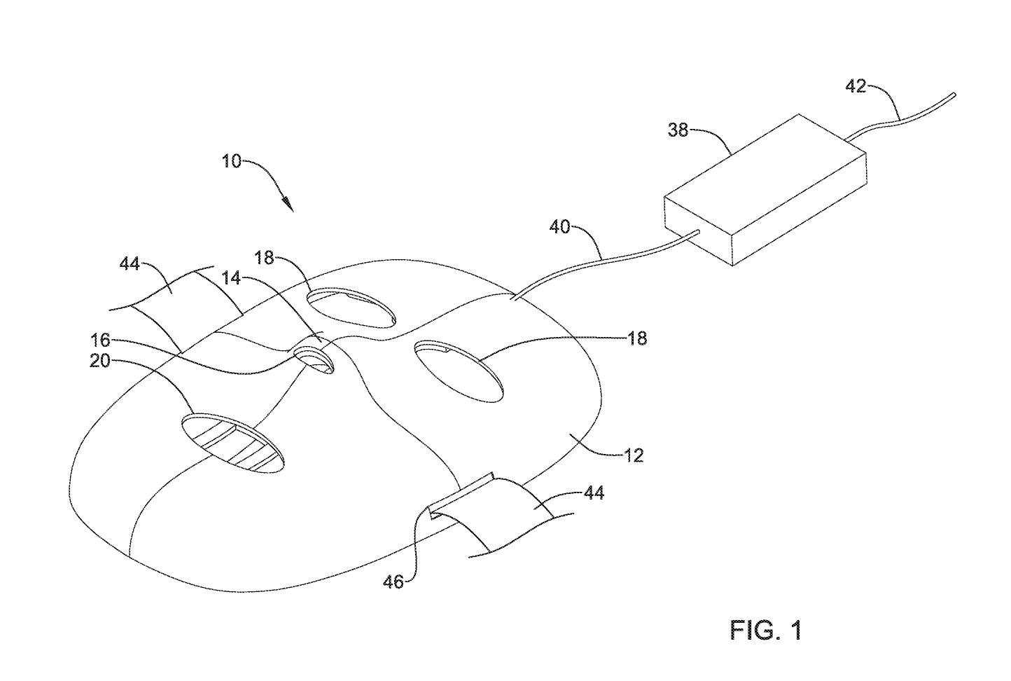

Generally, disclosed herein is a facial massaging mask. FIG. 1 illustrates a perspective view of an illustrative facial massaging mask 10. The massaging mask 10 may include a rigid or semi-rigid outer cover 12. For example, the outer cover 12 may be made of a polymeric material that resists deformation. Some illustrative polymeric materials may include acrylonitrile butadiene styrene (ABS) or polypropylene (PP), however other materials (polymeric, composite, ceramic, metal, etc.) may be used as desired. In particular, the polymeric material can comprise any polymeric material having a hardness and elasticity that are within a preferred range. The outer cover 12 may be formed (e.g. molded, cast, etc.) to generally conform to the shape of a human face. For example, the outer cover 12 may have a generally oblong shape, although this is not required. It is contemplated that the outer cover 12 may be more circular, rectangular, or square, as desired. In some embodiments, the outer cover 12 may have a thickness in the range of 1 to 20 millimeters (mm). However, it is contemplated that the outer cover 12 may have a thickness of less than 1 mm or greater than 20 mm, as desired.

The outer cover 12 may further include a raised central region 14 configured to be positioned over a person's nose. This may allow the mask 10 to be positioned comfortably against a person's face (e.g. forehead, cheeks, chin, etc.). The raised central region 14 may further include a first aperture 16 configured to allow air to pass through the mask 10 to a person's nose to allow the user to breathe comfortably when the mask 10 is positioned on a user's face. However, the aperture 16 may be formed as two or more grouped apertures. The outer cover 12 may further include one or more apertures 18 configured to be positioned over a user's eyes to allow the person to see while wearing the mask 10. The outer cover 12 may also include one or more apertures 20 configured to be positioned over a user's mouth to allow the person to breathe and/or speak while wearing the mask 10.

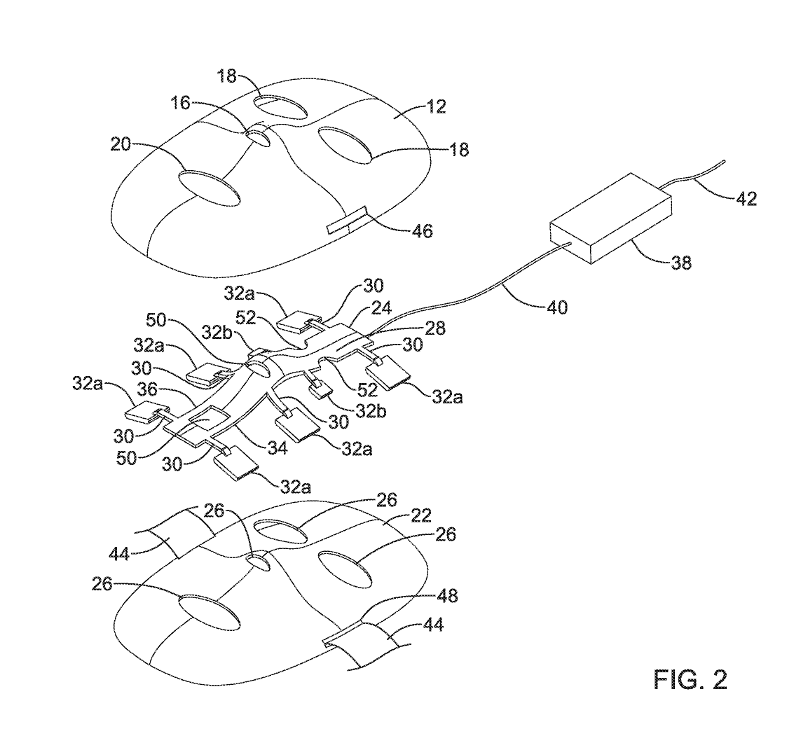

Referring additionally to FIG. 2, which illustrates an exploded view of the illustrative mask 10 of FIG. 1, the mask 10 may include an inner liner 22 and an intermediate frame 24 configured to be disposed between the outer cover 12 and the inner liner 22. The outer cover 12, intermediate frame 24, and inner liner 22 may be fixedly or releaseably secured to one another through any number of fixation mechanisms including, but not limited to, adhesives, snaps, hook and loop fasteners, etc.

The inner liner 22 may include one or more apertures 26. The apertures 26 may be configured to align with some or all of the apertures 16, 18, 20 provided in the outer cover 12. In some instances, the apertures 26 may be similarly sized and shaped to the corresponding apertures 16, 18, 20 provided in the outer cover 12 although this is not required.

The inner liner 22 may be formed of a thin layer of soft material to provide comfort to the user when the mask 10 is positioned on the face. The inner liner 22 may have a thickness in the range of 1 to 5 millimeters. In some instances, the inner liner 22 may be formed from a deformable material to allow portions of the mask 10 to conform to a profile of the user's face. It is contemplated that the inner liner 22 may be formed of a foam or gel material. In some instances, a gel capable of delivering a sensation of coolness, at ambient temperatures, without the need for refrigeration or outside cooling could be used. Gels in combination with refrigeration or outside cooling may also be used by, for example, including a circulating system for circulation of a cooling fluid. The gel may be directly exposed to the user's face, or there may be include a thin encapsulant layer over a gel material.

Any suitable gel technology may be employed. The gel is generally a polymer composition which exhibits both liquid and solid characteristics, depending upon the particular composition, that is, the gel can range from a semi-liquid to a semi-solid. In some aspects, the gel composition may contain a three-dimensional network of cross-linked molecular chains (gels), or it may merely behave as if it contained such a network (gelloids). In some instances, the gel may be encased by a coating, membrane, or shell, or be capable of standing alone or combinations of such materials. When a coating, membrane, or shell is used, it can be a polymeric or other material capable of containing even semi-liquid gels, and providing resilient structure for the gel which permits a desired amount of deformation, while enough resiliency to return to its original shape. The gel may also include phase change materials which are useful in conveying the cooling sensation, since phase change materials, by definition absorb heat energy when changing phases.

The gel of embodiments described in this document may be any liquid-extended polymer or a gelatinous composition having a molecular weight and hardness characteristics that allow the gel to deform yet have a resilience that allows it to rebound into its original shape quickly, such as within one second or less, when the load is removed. Examples of gels used in aspects of the invention include, without limitation, oil-extended triblock copolymer compositions such as that disclosed in U.S. Pat. No. 3,485,787, U.S. Pat. No. 3,676,387, U.S. Pat. No. 3,827,999, U.S. Pat. No. 4,176,240, U.S. Pat. No. 4,259,540, U.S. Pat. No. 4,351,913, U.S. Pat. No. 4,432,607, U.S. Pat. No. 4,492,428, U.S. Pat. No. 4,497,538, U.S. Pat. No. 4,509,821, U.S. Pat. No. 4,709,982, U.S. Pat. No. 4,716,183, U.S. Pat. No. 4,833,193, U.S. Pat. No. 4,942,270, U.S. Pat. No. 5,149,736, U.S. Pat. No. 5,331,036, and U.S. Pat. No. 5,994,450; and thermoplastic elastomer gelatinous compositions such as that disclosed in U.S. Pat. No. 4,369,284, U.S. Pat. No. 4,618,213, U.S. Pat. No. 5,262,468, U.S. Pat. No. 5,508,334, U.S. Pat. No. 5,153,254, U.S. Pat. No. 5,334,646, U.S. Pat. No. 5,239,273, U.S. Pat. No. 5,475,890, and U.S. Pat. No. 5,336,708. Each of the above references is hereby incorporated by reference.

The gel can comprise any gel that is stable, nontoxic, and generally known to provide a cushioning effect while maintaining a degree of structural stability and support. In particular, the gel can comprise any gel material having a hardness and elasticity that are within a preferred range. In some embodiments, the inner liner 22 may have a hardness in the range of 1 to 65 Shore OO.

Polyurethane gels are particularly useful. Further, other gels that are resistant to hardening over time, have limited expandability, and are resistant to substance degradation (e.g., from migration of volatile agents, such as plasticizers) could also be useful as the gel in the present invention.

Examples of polyurethane gels capable of use according to the invention are disclosed in U.S. Pat. No. 6,191,216, United States Published Patent Application No. 2004/0058163 (application Ser. No. 10/618,558) and U.S. Published Patent Application No. 2004/0102573 (application Ser. No. 10/656,778), which are incorporated herein by reference. Examples of other types of gels useful according to the invention are disclosed in U.S. Pat. No. 4,404,296, U.S. Pat. No. 4,456,642, and U.S. Published Patent Application No. 2007/0061978 (application Ser. No. 11/365,473), which are incorporated herein by reference.

Any gel technology or combinations of such technologies may be used. Some gel materials may be moldable and deformable upon contact. These materials may also convey a sensation of coolness, without requiring refrigeration or external cooling. Many suitable gel materials provide a sensation of coolness when touched to the skin, and to the extent it eventually heats up during contact, the gel material returns to a cooling state when returned to ambient temperature.

The intermediate frame 24 may include a central bridge portion 28 and a plurality of arms 30 extending from a first side 34 of the bridge 28 and a second side 36 of the bridge 28. The arms may extend generally perpendicular to a longitudinal axis of the bridge portion 28. It is contemplated that the arms 30 may extend from the bridge portion at non-orthogonal angles, as desired. Other angles may be used, however.

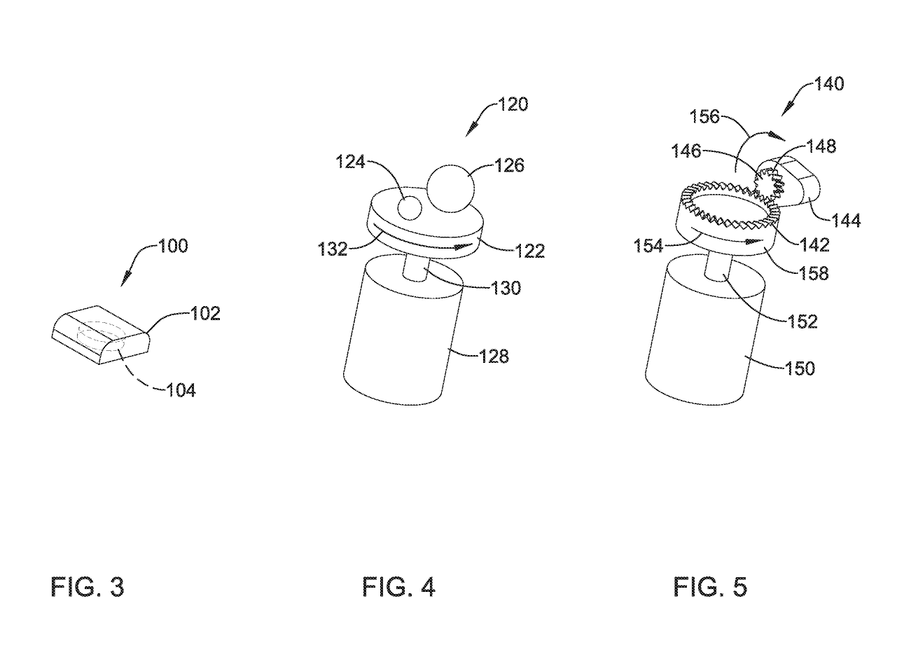

A massaging node 32a, 32b (collectively 32) may be positioned at the distal end of each of the plurality of arms 30. The massaging nodes 32 may have varying shapes and sizes from one another. For example, the massaging nodes 32b configured to be positioned below a user's eyes, or other more sensitive regions, may be smaller than the massaging nodes 32a configured to be positioned at other regions of the face. Further, while the massaging nodes 32 are illustrated as having a generally square cross-sectional shape, it is contemplated that the massaging nodes 32 may take any shape desired such as, but not limited to circular, oblong, rectangular, polygonal, etc. The massaging nodes 32 may be configured to provide a massaging motion, such as, but not limited to: vibration, sweeping, rotation, pressure point, etc. to the face as will be discussed in more detail below with respect to FIGS. 3-5 and 7-12.

Each massage node 32 may include its own contained actuator or motor for vibration, rotation, etc. The massaging nodes 32 may be configured to deliver the same type of massaging motion or different types of massaging motions as desired. For example, in some embodiments all of the massaging nodes 32 may be configured to vibrate. In other embodiments, some of the massaging nodes 32 may provide a sweeping action and some massaging nodes 32 may provide pressure point stimulation. The massaging nodes 32 may include any combination of massaging motions desired.

The bridge portion 28 of the intermediate frame 24 may be configured to extend generally along the center line of the face from the forehead to the chin. The intermediate frame 24 may be formed from a semi-rigid material. As used herein a semi-rigid material is a material that is rigid enough to maintain its shape while also allowing the arms 30 to flex (e.g. for better contact of the massage nodes 32 with the face). In some instances, the intermediate frame 24 may be made from thin polypropylene or polyethylene. The intermediate frame 24 may have a thickness in the range of 0.5 to 2 mm. The intermediate frame 24 may include one or more apertures 50 and/or recesses 52. The apertures 50 and/or recesses 52 may be configured to align with some or all of the apertures 16, 18, 20 provided in the outer cover 12 and/or apertures 26 provided in the inner liner 22. In some instances, the apertures 52 and/or recesses may be similarly sized and shaped to the corresponding apertures 16, 18, 20 provided in the outer cover 12 and/or apertures 26 provided in the inner liner 22, although this is not required.

While the mask 10 is illustrated as including eight arms 30 and eight corresponding massaging nodes 32, it is contemplated that the mask 10 may include any number of arms 30 and/or massaging nodes 32 desired. In some illustrative examples, there may be at least one, or at least two, or at least six arms 30 and corresponding massaging nodes 32. In some instances, the mask 10 may include in the range of 2-16 massaging nodes 32. Further, the mask 10 may include more than one massaging node 32 positioned on or along any given arm 30. For example, one or more of the plurality of arms 30 may include two or more massaging nodes 32 positioned along a length of the arm 30. In some embodiments, the arms 30 and/or massaging nodes 32 may be symmetrically positioned. For example, there may be the same number of arms 30 extending from either side 34, 36 with the same configuration of massaging nodes 32 on either side 34, 36. In other embodiments, the arms 30 and/or massaging nodes 32 may be asymmetrically configured. For example, there may be a differing number of arms extending from either side 34, 36 and/or a differing configuration of massaging nodes 32 on either side 34, 36.

The massaging nodes 32 may each be electrically connected to a control module or control box 38 through one or more conduits 40, such as or including electrical connectors. In some instances, the conduit 40 may be a tubular element for receiving electrical conductors therein. It is contemplated that the conduit 40 may house other tubular elements, such as tubing for circulating cooling and/or heating fluid to the mask 10 to provide additional therapies. In some instances, the massage nodes 32 may be independently connected to the control module 38 such that a user can regulate each massage node 32 individually (e.g. on/off, speed, etc.) such that the user can customize which massage nodes 32 are active and/or the intensity of the massaging motion. Alternatively, the massaging nodes 32 may be collectively controlled such that they are all simultaneously activated and at the same speed. The control module 38 may regulate the speed (e.g. intensity) of the massage nodes 32 by controlling the voltage provided to the massage nodes 32.

The control module 38 may further include a power cord 42 configured to supply power to the control module and/or massage nodes 32 from a wall source (e.g. wall outlet). Alternatively, or additionally, power may be supplied via one or more batteries disposed within the control module 38. While not explicitly shown, the control box 38 may include an actuatable element for controlling the power supply to the massage nodes 32. In some instances, the actuatable element may be a binary on/off switch in the form of a toggle switch, pushbutton switch, selector switch, or other binary on/off switch, or plural such switches, as desired. In other instances, the actuatable element may allow for variable power to be supplied to the massaging nodes and may be in the form of a sliding switch, rotatable dial, or other variable switch as desired. In some embodiments, a plurality of actuatable elements may be provided such that the massage nodes 32 may be individually controlled. Alternatively, or additionally, the control module 38 may be provided with a user interface, such as, but not limited to a touch screen, that allows a user to select which massage nodes 32 are activated and at what intensity.

In some embodiments, the control module 38 may be further configured to provide cooling and/or heating to the mask 10. For example, the control module 38 may include a cooling, refrigeration, compressor, and/or heating apparatus which circulate cooling and/or heating fluid to the mask. The cooling and/or heating fluid may be circulated through the conduit 40 to provide cooling and/or heating therapies to the user in addition to or in place of massage therapies delivered by the nodes 32.

The outer cover 12 of the mask 10 may include two or more apertures or slots 46 formed on opposite sides therein each configured to removably receive a strap 44 or other retention feature. The apertures 46 may be located on either side of the raised central region 14 adjacent to the edges of the outer cover 12. The inner liner 22 may also include two or more apertures or slots 48 generally aligned with the slots 46 of the outer cover 12. A first end of a strap 44 may be positioned and secured (releaseably or fixedly) within the slots 44, 46. A second end of the strap 44 may be wrapped around the back of the head. In some instances, the second end of the strap 44 may be advanced through the slots 44, 46 on the opposing side of the mask 10. The strap 44 may have an adjustable length or be formed from an elastic material to accommodate varying head sizes. In other instances, two straps 44 may be provided and the second ends of the straps may be secured to one another behind the head.

Some illustrative securing mechanisms for use with the strap(s) 44 may include, but are not limited to: hook and loop fasteners (e.g. VELCRO®), buttons, snaps, hooks, etc. Multiple securing mechanisms may be provided to allow the straps 44 to have an adjustable length. The strap(s) 44 may be configured to wrap behind a user's head to secure the mask 10 to a user's face such that the mask 10 may be used without requiring the user to hold it in place. In some embodiments, the strap(s) 44 may be secured directly to the outer cover 12 and/or inner liner 22 of the mask 10 and slots 44, 46 may be omitted.

FIG. 3 is a perspective view of an illustrative massage node 100. The illustrative massage node may be a vibrating massage node 100. The vibrating massage node 100 may include a vibrating disc 102 disposed within an outer housing 104. It is contemplated that the housing 104 may be made from any material desired, such as, but not limited to polymers, metals, ceramics, composites, etc. It is contemplated that a metal housing 104 may provide additional cooling effects. The vibrating disc 102 may be in electrical communication with a control module, such as the control module 38 described above. The control module may provide power to the vibrating disc 102 such that the disc 102 vibrates. The vibrations may be passed through the inner liner of the mask, such as the inner liner 22 described above, to a user's face. The vibrating disc 102 and associated housing 104 may have varying sizes and/or intensities depending on the location of the particular node 100 within the mask. For example, a node 100 positioned under the eyes may be smaller and/or gentler than a node 100 positioned on the forehead, although this is not required. In some embodiments, the node 100 may have a diameter or width in the range of 5 to 30 mm.

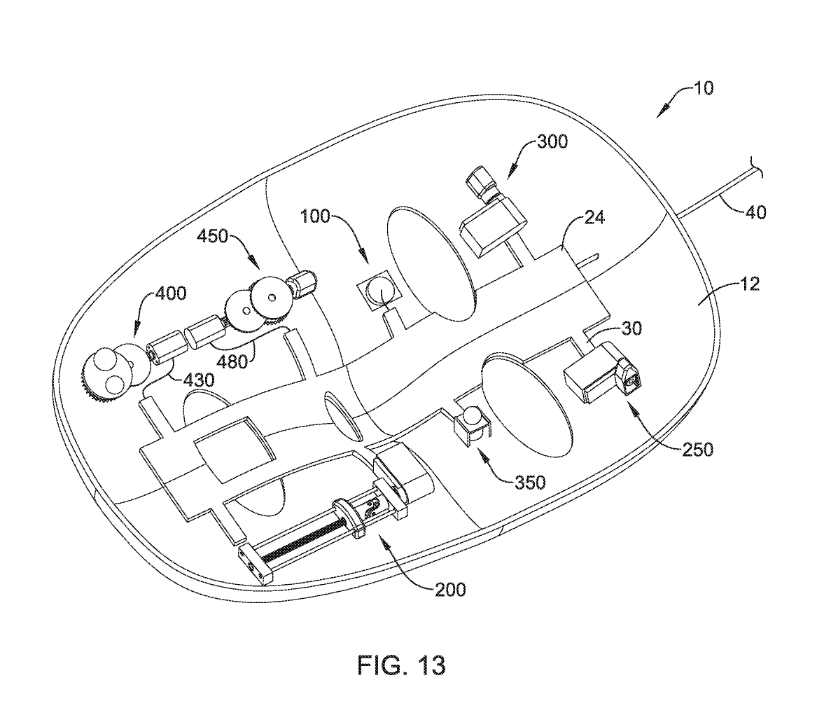

FIG. 13 illustrates the massage node 100 positioned within the mask 10 with the inner liner 22 removed for clarity. It should be understood that the massage node may be positioned entirely between the outer cover 12 and the inner liner 22.

FIG. 4 is a perspective view of another illustrative massage node 120. The massage node may be a rotating massage node 120. The node 120 may have a base 122 and one or more rounded massages elements 124, 126. While the massage elements 124, 126 are illustrated as generally spherical, it is contemplated that the massage elements 124, 126 may take other forms, such as, but not limited to: hemi-spherical, ovoid, eccentric. It is contemplated that the shape may be chosen such that sharp edges are minimized to reduce damage to the inner liner 22 and/or for the comfort of the user. It is contemplated that the node 120 may include any number of massage element 124, 126, such as, but not limited to, one, two, three, four or more. The massage elements 124, 126 may have varying sizes. For example, a smaller massage element 124 and a large massage element 126 may be provided to provide a kneading action. However, this is not required. In some embodiments, the massage elements 124, 126 may all have a similar size while in other embodiments the massage elements 124, 126 may all have differing sizes. Combinations of similarly sized massage elements 124, 126 and differently sized massage elements 124, 126 may be used.

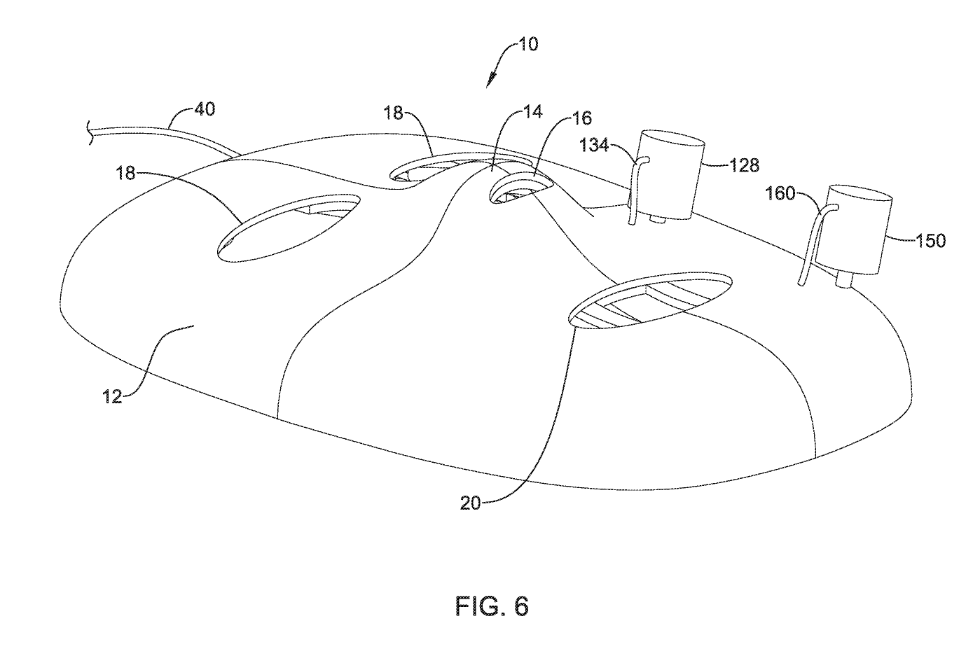

The base 122 may be attached to a motor 128 through a shaft 130. The motor 128 may receive power from the control module 38 to drive the shaft 130. In some instances, the motor 128 may drive a rotatable shaft disposed within shaft 130. The base 122 may be affixed to the rotatable portion of the shaft 130 such that rotation of the shaft 130 also results in rotation (shown at arrow 132) of the base 122 and the attached massage elements 124, 126. This may create a kneading style massage. While not explicitly shown, the shaft 130 may be configured to pass through an aperture in the outer cover 12. The motor 128 may be positioned on an outer surface (e.g. facing away from the face when the mask 10 is positioned on a face) of the outer cover 12 as shown in FIG. 6. Alternatively, the motor may instead be replaced with an actuator that allows placement between the inner and outer layers of a mask as shown in FIG. 2 and/or FIG. 13.

The control module 38 may provide power to the motor 128 through an electrical conductor 134 (see FIG. 6) such that the base 122 ultimately rotates. The electrical conductor 134 may be disposed within the intermediate frame 24 and exit the outer cover 12 through an aperture (not explicitly shown) formed therein. The massaging elements 124, 126 may be pressed against user's face through the inner liner 22 of the mask 10. The rotating massaging elements 124, 126 may create a kneading sensation on the user's face. It is contemplated that the speed at which the shaft 130 rotates (and hence massaging elements 124, 126) may be dependent upon the amount of power provided to the motor 128 by the control module 38 and/or the size of the motor 128. Alternatively, or additionally, the motor 128 may include additional gearing between the shaft 130 and the base 122 that changes the speed at which the base 122 ultimately rotates. Though not shown in FIG. 6, the intensity of massaging motion may also be controlled by allowing the user to raise or lower the actuators/motors 128 relative to the outer surface of the mask 10.

FIG. 5 is a perspective view of another illustrative massage node 140. The massage node may be a rotating massage node 140 configured to deliver a sweeping style therapy. The node 140 may have a rotating disc 158 including a plurality of gear teeth 142 disposed on an end surface thereof. The gear teeth 142 may be configured to engage and mate with corresponding gear teeth 148 disposed on a raised portion 146 of a rotating cam 144. The rotating cam 144 may have a generally eccentric shape. The raised portion 146 may be disposed closer to one end of the cam 144 such that as the cam 144 rotates (as shown at 156), the end of the cam 144 opposite raised portion applies an intermittent sweeping pressure the user's face. It is contemplated that the shape of the cam 144 may be chosen such that sharp edges are minimized to reduce damage to the inner liner 22 and/or for the comfort of the user. It is contemplated that the node 140 may include any number of cams 144 positioned about the circumference of the disc 158, such as, but not limited to, one, two, three, four or more. If more than one cam 144 is provided, the cams 144 may have varying sizes although this is not required. If multiple cams 144 are provided combinations of similarly sized cams 144 and differently sized cams 144 may be used. It is contemplated that a smaller cam may exert less pressure than a larger cam as they rotate.

The disc 158 may be attached to a motor 150 through a shaft 152. The motor 150 may receive power from the control module 38 to drive the shaft 152. In some instances, the motor 150 may drive a rotatable shaft disposed within shaft 152. The disc 158 may be affixed to the rotatable portion of the shaft 152 such that rotation of the shaft 152 also results in rotation (shown at arrow 154) of the disc 158. As the disc 158 rotates 154, the teeth 142 of the disc 158 engage the teeth 148 of the cam 144 causing the cam to rotate 156. Such motion may create a kneading style massage. While not explicitly shown, the shaft 152 may be configured to pass through an aperture in the outer cover 12. The motor 150 may be positioned on an outer surface (e.g. facing away from the face when the mask 10 is positioned on a face) of the outer cover 12 (as shown in FIG. 6).

The control module 38 may provide power to the motor 150 through an electrical conductor 160 (see FIG. 6) such that the disc 158 ultimately rotates. The electrical conductor 160 may be disposed within the intermediate frame 24 and exit the outer cover 12 through an aperture (not explicitly shown) formed therein. The cam 144 may be intermittently pressed against user's face through the inner liner 22 of the mask 10. The rotation of the cam 144 may create a sweeping pressure on the user's face. It is contemplated that the speed at which the shaft 152 rotates (and hence cam 144) may be dependent upon the amount of power provided to the motor 150 by the control module 38 and/or the size of the motor 150. Alternatively, or additionally, the motor 150 may include additional gearing between the shaft 152 and the disc 158 that changes the speed at which the disc 158 ultimately rotates.

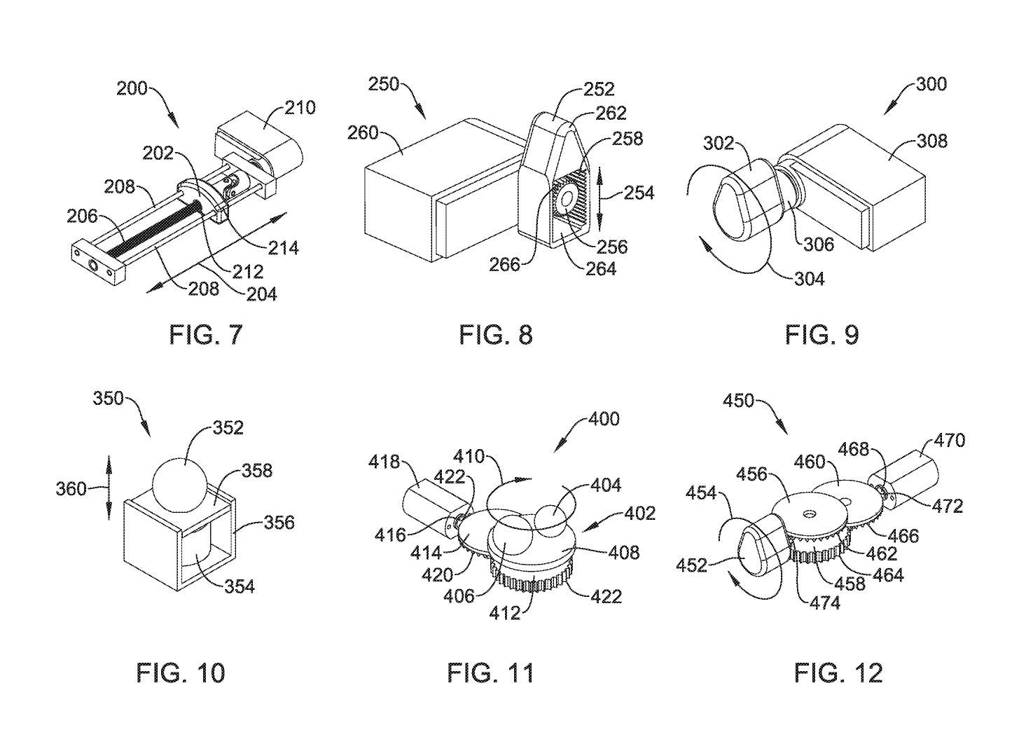

FIG. 7 is a perspective view of another illustrative massage node 200. The massage node may be a sweeping massage node 200 configured to deliver a sweeping style therapy. The node 200 may have a sweeping massage element 202. The massage element 202 may be configured to move in a back and forth, or sweeping, motion along a longitudinal axis 204 of the massage node 200. It is contemplated that the shape of the massage element 202 may be chosen such that sharp edges are minimized to reduce damage to the inner liner 22 and/or for the comfort of the user. For example, a surface 214 of the massage element 202 facing the user's face when the mask is in use may be a smooth, and in some instances curved, surface. It is contemplated that the massage node 200 may include more than one massage element 202. If more than one massage element 202 is provided, the massage elements 202 may have varying sizes although this is not required. If multiple massage elements 202 are provided combinations of similarly sized massage elements 202 and differently sized massage elements 202 may be used. It is contemplated that a smaller massage element 202 may exert less pressure than a larger massage element 202 as they actuate.

The massage element 202 may be coupled to, or otherwise engage, a thread drive 206 and, optionally, one or more guide posts 208. For example, the massage element 202 may include a threaded aperture 212 configured to mate with corresponding or mating threads on the thread drive 206. As the thread drive 206 rotates in a first direction, the massage element 202 may move along the thread drive 206 in a first linear direction and as the thread drive 206 rotates in a second direction opposite the first direction, the massage element 202 may move in a second linear direction opposite the first linear direction.

The thread drive 206 may be coupled to a servo motor 210, or other rotary or linear actuator, configured to rotate the thread drive 206. The thread drive 206 may convert rotational motion (from the servo motor 210) to linear motion 204 of the massage element 202. The rotation of the servo motor 210 may be reversible to allow the massage element 202 to move away from and towards the motor 210 along the thread drive 206. The control module 38 may provide power to the motor 210 through an electrical conductor (not explicitly shown) to drive the thread drive 206 such that the massage element 202 moves in a linear motion. The motor 210 may be configured, or otherwise programmed, to periodically change rotational directions to cause the thread drive 206 and hence the massage element 202 to move in an opposite direction to its previous direction. It is contemplated that the speed at which the thread drive 206 rotates (and corresponding speed of the massage element 202) may be dependent upon the amount of power provided to the motor 210 by the control module 38 and/or the size of the motor 210. The massage node 200 may be sized and shaped to be positioned between the outer cover 12 and the inner liner 22. FIG. 13 illustrates the massage node 200 positioned within the mask 10 with the inner liner 22 removed for clarity. However, it should be understood that the massage node may be positioned entirely between the outer cover 12 and the inner liner 22.

FIG. 8 is a perspective view of another illustrative massage node 250. The massage node may be a pulsing or tapping massage node 250 configured to deliver a rhythmic tapping style therapy. The node 250 may have a massage element 252 configured to oscillate along an axis 254 in a linear motion. The massage element 252 may be configured to move along a single axis 254 or maybe configured to move along more than one axis. For example, the massage element 252 may move along axis 254 and an axis generally perpendicular to axis 254. It is further contemplated that the massage element 252 may be configured to provide a sustained or continuous pressure. In some instants, the massage element 252 may have a tapered tip 262, although this is not required. The tip 262 may be generally curved such that sharp edges are minimized to reduce damage to the inner liner 22 and/or for the comfort of the user. It is contemplated that the massage node 250 may include more than one massage element 252. If more than one massage element 252 is provided, the massage elements 252 may have varying sizes although this is not required. If multiple massage elements 252 are provided combinations of similarly sized massage elements 252 and differently sized massage elements 252 may be used. It is contemplated that a smaller massage element 252 may exert less pressure than a larger massage element 252 as they actuate.

The massage element 252 may include a cavity 264 having a plurality of gear teeth 258 disposed along an inner surface thereof. The gear teeth 258 may be configured to engage and mate with corresponding gear teeth 266 disposed on a rotating shaft 256. The rotating shaft 256 and massage element 252 may function in a similar manner to a rack and pinion type linear actuator. Rotational movement of the shaft 256 may be translated into the linear movement 254 of the massage element 252. As the shaft 256 rotates in a first direction, the massage element 252 may move in a first linear direction and as the shaft 256 rotates in a second direction opposite the first direction, the massage element 252 may move in a second linear direction opposite the first linear direction.

The shaft 256 may be coupled to a servo motor 260, or other rotary or linear actuator, configured to rotate the shaft 256. The rotation of the servo motor 260 may be reversible to allow the massage element 252 to move back and forth in a linear motion parallel to axis 254. The control module 38 may provide power to the motor 260 through an electrical conductor (not explicitly shown) to drive the shaft 256 such that the massage element 252 moves in a linear manner. The motor 260 may be configured, or otherwise programmed, to periodically change rotational directions to cause the shaft 256 and hence the massage element 252 to move in an opposite direction to its previous direction. It is contemplated that the speed at which the shaft 256 rotates (and corresponding speed of the massage element 252) may be dependent upon the amount of power provided to the motor 260 by the control module 38 and/or the size of the motor 260. The massage node 250 may be sized and shaped to be positioned between the outer cover 12 and the inner liner 22. FIG. 13 illustrates the massage node 250 positioned within the mask 10 with the inner liner 22 removed for clarity. However, it should be understood that the massage node may be positioned entirely between the outer cover 12 and the inner liner 22.

FIG. 9 is a perspective view of another illustrative massage node 300. The massage node 300 may be a rotating massage node configured to deliver a sweeping style therapy. The node 300 may have a rotating shaft 306 and a cam attachment 302 positioned at an end of the shaft 306. The cam 302 may have a generally eccentric shape. The cam 302 may be positioned such that as it rotates 304 an end of the cam 302 applies an intermittent sweeping pressure the user's face. It is contemplated that the shape of the cam 302 may be chosen such that sharp edges are minimized to reduce damage to the inner liner 22 and/or for the comfort of the user. It is contemplated that the massage node 300 may include more than one cam 302. If more than one cam 302 is provided, the cams 302 may have varying sizes although this is not required. If multiple cams 302 are provided combinations of similarly sized cams 302 and differently sized cams 302 may be used. It is contemplated that a smaller cam may exert less pressure than a larger cam as they rotate.

The cam 302 may be attached to a servo motor 308, or other rotary or linear actuator, through the shaft 306. The motor 308 may receive power from the control module 38 to drive the shaft 306. In some instances, the motor 308 may drive a rotatable shaft disposed within shaft 306. The cam 302 may be affixed to the rotatable portion of the shaft 306 such that rotation of the shaft 306 also results in rotation (shown at arrow 304) of the cam 302. Such motion may create a kneading style massage. In some instances, the cam 302 may rotate continuously (e.g. a full 360° rotation) while in other instances, the cam 302 may only partially rotate (e.g. complete less than a 360° rotation). For example, the cam 302 may rotate 180° or less to provide more consistent contact with the skin. The rotation of the servo motor 308 may be reversible to allow the cam 302 to move in a first rotational direction (e.g. clockwise) and a second rotational direction (e.g. counter-clockwise).

The control module 38 may provide power to the motor 308 through an electrical conductor (not explicitly shown) such that the cam 302 ultimately rotates. The cam 302 may be intermittently pressed against user's face through the inner liner 22 of the mask 10. The rotation and/or oscillation of the cam 302 may create a sweeping pressure on the user's face. It is contemplated that the speed at which the shaft 306 rotates (and hence cam 302) may be dependent upon the amount of power provided to the motor 308 by the control module 38 and/or the size of the motor 308. Alternatively, or additionally, the motor 308 may include additional gearing between the shaft 306 and the cam 302 that changes the speed at which the cam 302 ultimately rotates. The massage node 300 may be sized and shaped to be positioned between the outer cover 12 and the inner liner 22. FIG. 13 illustrates the massage node 300 positioned within the mask 10 with the inner liner 22 removed for clarity. However, it should be understood that the massage node may be positioned entirely between the outer cover 12 and the inner liner 22.

FIG. 10 is a perspective view of another illustrative massage node 350. The massage node may be a pulsing or tapping massage node 350 configured to deliver a rhythmic tapping style therapy. The node 350 may have a massage element 352 configured to oscillate along an axis 360 in a linear motion. The massage element 352 may be configured to move along a single axis 360 or maybe configured to move along more than one axis, as desired It is further contemplated that the massage element 352 may be configured to provide a sustained or continuous pressure. In some instants, the massage element 352 may have a generally spherical shape, although this is not required. The massage element 352 may be generally curved such that sharp edges are minimized to reduce damage to the inner liner 22 and/or for the comfort of the user. It is contemplated that the massage node 350 may include more than one massage element 352. If more than one massage element 352 is provided, the massage elements 352 may have varying sizes although this is not required. If multiple massage elements 352 are provided combinations of similarly sized massage elements 352 and differently sized massage elements 352 may be used. It is contemplated that a smaller massage element 352 may exert less pressure than a larger massage element 352 as they actuate.

The massage element 352 may be disposed on a surface 358 of a housing 356. While not explicitly shown, the surface 358 may include an opening for receiving an actuating element therethrough. The actuating element may be or may be connected to a solenoid valve 354. The solenoid valve 354 or other linear actuator, configured to actuate the massage element 352. The oscillation of the solenoid valve 354 may be reversible to allow the massage element 352 to move back and forth in a linear motion parallel to axis 360. The control module 38 may provide power to the solenoid valve 354 through an electrical conductor (not explicitly shown) to drive the massage element 352 in a linear manner. It is contemplated that the speed at which the solenoid valve 354 oscillates (and corresponding speed of the massage element 352) may be dependent upon the amount of power provided to the solenoid valve 354 by the control module 38 and/or the size of the solenoid valve 354. The massage node 350 may be sized and shaped to be positioned between the outer cover 12 and the inner liner 22. FIG. 13 illustrates the massage node 350 positioned within the mask 10 with the inner liner 22 removed for clarity. However, it should be understood that the massage node may be positioned entirely between the outer cover 12 and the inner liner 22.

FIG. 11 is a perspective view of another illustrative massage node 400. The massage node may be a rotating massage node 400. The node 400 may have a rotating massage element 402 including at least a base 408 and one or more rounded massages elements 404, 406. While the massage elements 404, 406 are illustrated as generally spherical, it is contemplated that the massage elements 404, 406 may take other forms, such as, but not limited to: hemi-spherical, ovoid, eccentric. It is contemplated that the shape may be chosen such that sharp edges are minimized to reduce damage to the inner liner 22 and/or for the comfort of the user. It is contemplated that the node 400 may include any number of massage element 404, 406, such as, but not limited to, one, two, three, four or more. The massage elements 404, 406 may have varying sizes. For example, a smaller massage element 404 and a large massage element 406 may be provided to provide a kneading action. However, this is not required. In some embodiments, the massage elements 404, 406 may all have a similar size while in other embodiments the massage elements 404, 406 may all have differing sizes. Combinations of similarly sized massage elements 404, 406 and differently sized massage elements 404, 406 may be used.

The base 408 may be attached to a motor 418 through a shaft 416 and one or more gears 412, 414, 422. In some instances, the motor 418 may drive a rotatable shaft disposed within shaft 416. While three gears 412, 414, 422 are illustrated, it is contemplated that the massage node 400 may include fewer than three gears or more than three gears, as desired. The motor 418 may receive power from the control module 38 through an electrical conductor 430 (see, for example, FIG. 13) to drive the shaft 416. As the shaft 416 rotates, a first gear 422 affixed to the shaft 416 may rotate in a first plane. Gear teeth (not explicitly shown) of the first gear 422 may be configured to engage corresponding gear teeth 420 of a second gear 414. As the first gear 422 rotates, the second gear 414 may rotate in a second plane generally perpendicular to the first plane. The gear teeth 420 of the second gear 414 may be configured to engage gear teeth 422 of a third gear 412 such that rotation of the shaft 416 ultimately rotates the third gear 412. The base 408 of the rotating element 402 may be affixed directly to, indirectly to (e.g. via an elongate shaft), or formed as a unitary structure with the third gear 412. In some embodiments, the base 408 may be affixed to or otherwise formed with the second gear 414 eliminating the need for the third gear 412.

The base 408 may be affixed to the gears 412, 414 such that rotation of the shaft 416 also results in rotation (shown at arrow 410) of the base 408 and the attached massage elements 404, 406. This may create a kneading style massage. The control module 38 may provide power to the motor 418 through an electrical conductor 430 (see FIG. 13) such that the base 408 ultimately rotates. The electrical conductor 430 may be disposed within the intermediate frame 24. The massaging elements 404, 406 may be pressed against user's face through the inner liner 22 of the mask 10. The rotating massaging elements 404, 406 may create a kneading sensation on the user's face. It is contemplated that the speed at which the shaft 416 rotates (and hence massaging elements 404, 406) may be dependent upon the amount of power provided to the motor 418 by the control module 38 and/or the size of the motor 418. Alternatively, or additionally, the motor 418 may include additional gearing between the shaft 416 and the base 408 that changes the speed at which the base 408 ultimately rotates. FIG. 13 illustrates the massage node 400 positioned within the mask 10 with the inner liner 22 removed for clarity. However, it should be understood that the massage node may be positioned entirely between the outer cover 12 and the inner liner 22.

FIG. 12 is a perspective view of another illustrative massage node 450. The massage node may be a rotating massage node 450 configured to deliver a sweeping style therapy. The node 450 may have a rotating shaft 468 and a cam attachment 452 attached to the shaft 468 through a series of gears 474, 472, 460, 458, 456. The cam 452 may have a generally eccentric shape. The cam 452 may be positioned such that as it rotates (shown at arrow 454) an end of the cam 452 applies an intermittent sweeping pressure the user's face. It is contemplated that the shape of the cam 452 may be chosen such that sharp edges are minimized to reduce damage to the inner liner 22 and/or for the comfort of the user. It is contemplated that the massage node 450 may include more than one cam 452. If more than one cam 452 is provided, the cams 452 may have varying sizes although this is not required. If multiple cams 452 are provided combinations of similarly sized cams 452 and differently sized cams 452 may be used. It is contemplated that a smaller cam may exert less pressure than a larger cam as they rotate.

The cam 452 may be attached to a motor 470 through a rotatable shaft 468 and one or more gears 474, 472, 460, 458, 456. In some instances, the motor 470 may drive a rotatable shaft disposed within shaft 468. While five gears 474, 472, 460, 458, 456 are illustrated, it is contemplated that the massage node 450 may include fewer than five gears or more than five gears, as desired. The motor 470 may receive power from the control module 38 through an electrical conductor 480 (see, for example, FIG. 13) to drive the shaft 468. As the shaft 468 rotates, a first gear 472 affixed to the shaft 468 may rotate in a first plane. Gear teeth (not explicitly shown) of the first gear 472 may be configured to engage corresponding gear teeth 466 of a second gear 460. As the first gear 468 rotates, the second gear 460 may rotate in a second plane generally perpendicular to the first plane. The gear teeth 466 of the second gear 460 may be configured to engage gear teeth 464 of a third gear 458 such that rotation of the shaft 468 ultimately rotates the third gear 458. The third gear 458 may be affixed to a fourth gear 456 through an elongate shaft or other structure (not explicitly shown) such that as the third gear 458 rotates, the fourth gear 456 also rotates without the direct engagement of any gear teeth. The fourth gear 456 may include a plurality of gear teeth 462 configured to engage corresponding gear teeth (not explicitly shown) of a fifth gear 474. As the fourth gear 456 rotates, the fifth gear 460 may rotate in a plane generally parallel to the first plane. The cam 452 may be affixed directly to, indirectly to (e.g. via an elongate shaft), or formed as a unitary structure with the fifth gear 474. In some embodiments, the cam 452 may be affixed to or otherwise formed with the first gear 472 eliminating the need for additional gearing.

The cam 452 may be affixed to the gears 474, 472, 460, 458, 456 such that rotation of the shaft 468 also results in rotation (shown at arrow 454) of the cam 452. This may create a sweeping style massage. In some instances, the cam 452 may rotate continuously (e.g. a full 360° rotation) while in other instances, the cam 452 may only partially rotate (e.g. complete less than a 360° rotation). For example, the cam 452 may rotate 180° or less to provide more consistent contact with the skin. The rotation of the shaft 468 may be reversible to allow the cam 452 to move in a first rotational direction (e.g. clockwise) and a second rotational direction (e.g. counter-clockwise).

The control module 38 may provide power to the motor 470 through an electrical conductor 480 (see FIG. 13) such that the cam 452 ultimately rotates. The electrical conductor 480 may be disposed within the intermediate frame 24. The cam 452 may be pressed against user's face through the inner liner 22 of the mask 10. The rotating cam 452 may create a sweeping style therapy on the user's face. It is contemplated that the speed at which the shaft 468 rotates (and hence cam 452) may be dependent upon the amount of power provided to the motor 470 by the control module 38 and/or the size of the motor 470. Alternatively, or additionally, the motor 470 may include additional gearing between the shaft 468 and the cam 452 that changes the speed at which the cam 452 ultimately rotates. FIG. 13 illustrates the massage node 450 positioned within the mask 10 with the inner liner 22 removed for clarity. However, it should be understood that the massage node may be positioned entirely between the outer cover 12 and the inner liner 22.

FIG. 13 illustrates a perspective view of the illustrative mask 10 including a plurality of different massage nodes 100, 200, 250, 300, 350, 400, 450 with the inner liner removed for clarity. It should be understood the massage nodes 100, 200, 250, 300, 350, 400, 450 may be positioned entirely between the outer cover and the inner liner 22. In some instances, the intermediate frame 24 may be omitted and/or the massage nodes may be disconnected from the intermediate frame 24. For example, the massage nodes 100, 200, 250, 300, 350, 400, 450 may be positioned between the outer cover 12 and the inner liner 22 with the electrical conductors also positioned between the outer cover 12 and the inner liner 22. It is contemplated that the massage nodes 100, 200, 250, 300, 350, 400, 450 may simply rest between the outer cover 12 and the inner liner 22, held in place by the securement of the outer cover 12 and the inner liner 22, or be secured in place with a mechanical means. It should be understood that the massage nodes positioned within the mask 10 may be of all the same type or any combination of types, as desired.

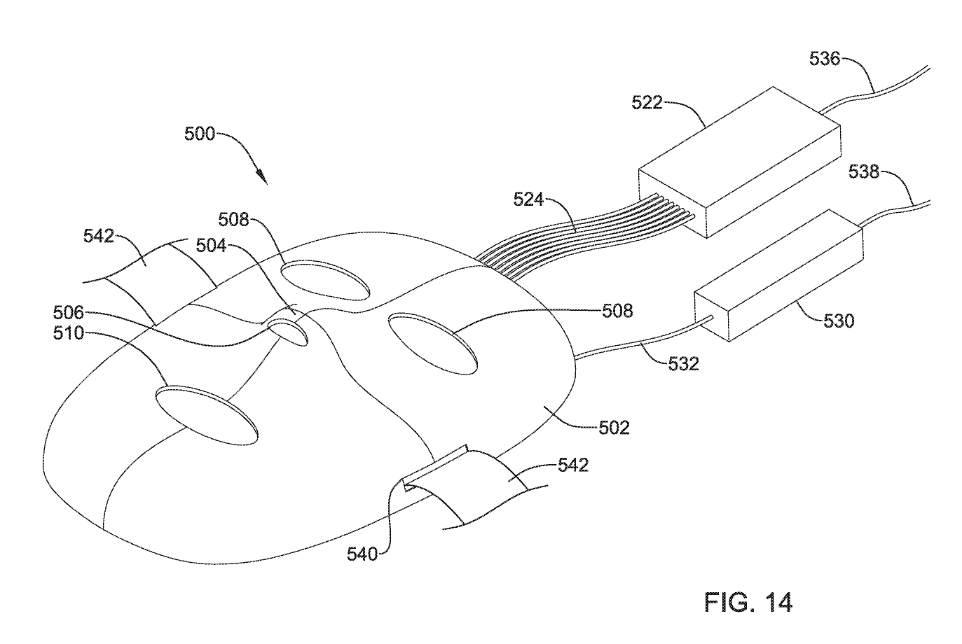

FIG. 14 illustrates a perspective view of another illustrative facial massaging mask 500. The massaging mask 500 may include a rigid or semi-rigid outer cover 502. For example, the outer cover 502 may be made of a polymeric material that resists deformation. Some illustrative polymeric materials may include acrylonitrile butadiene styrene (ABS) or polypropylene (PP), however other materials (polymeric, composite, ceramic, metal, etc.) may be used as desired. In particular, the polymeric material can comprise any polymeric material having a hardness and elasticity that are within a preferred range. The outer cover 502 may be formed (e.g. molded, cast, etc.) to generally conform to the shape of a human face. For example, the outer cover 502 may have a generally oblong shape, although this is not required. It is contemplated that the outer cover 502 may be more circular, rectangular, or square, as desired. In some embodiments, the outer cover 502 may have a thickness in the range of 1 to 20 millimeters (mm). However, it is contemplated that the outer cover 502 may have a thickness of less than 1 mm or greater than 20 mm, as desired.

The outer cover 502 may further include a raised central region 504 configured to be positioned over a person's nose. This may allow the mask 500 to be positioned comfortably against a person's face (e.g. forehead, cheeks, chin, etc.). The raised central region 504 may further include a first aperture 506 configured to allow air to pass through the mask 500 to a person's nose to allow the user to breathe comfortably when the mask 500 is positioned on a user's face. However, the aperture 506 may be formed as two or more grouped apertures or not present at all. The outer cover 502 may further include one or more apertures 508 configured to be positioned over a user's eyes to allow the person to see while wearing the mask 500, although this is not required. The outer cover 502 may also include one or more apertures 510 configured to be positioned over a user's mouth to allow the person to breathe and/or speak while wearing the mask 500, although this is not required.

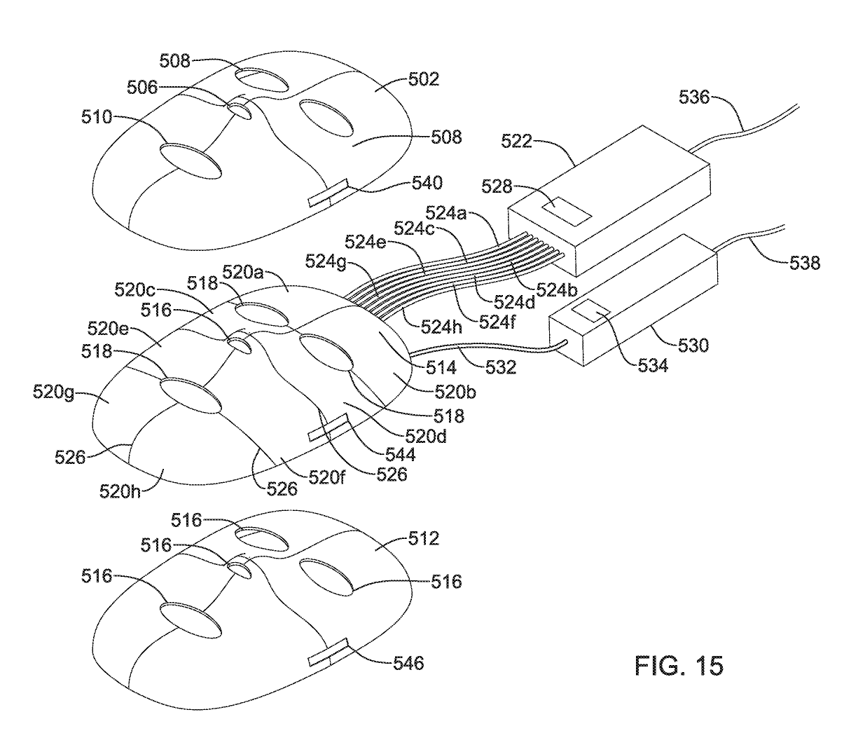

Referring additionally to FIG. 15, which illustrates an exploded view of the illustrative mask 500 of FIG. 14, the mask 500 may include an inner liner 512 and an intermediate pressure pouch 514 configured to be disposed between the outer cover 502 and the inner liner 512. The outer cover 502, intermediate pressure pouch 514, and inner liner 512 may be fixedly or releaseably secured to one another through any number of fixation mechanisms including, but not limited to, adhesives, snaps, hook and loop fasteners, etc. In some embodiments, the liner 512 may be positioned as the intermediate layer between the outer cover 502 and the pressure pouch 514 such that the pressure pouch 514 is configured to come into contact with a user's face.

The inner liner 512 may include one or more apertures 516. The apertures 516 may be configured to align with some or all of the apertures 506, 508, 510 provided in the outer cover 502. In some instances, the apertures 516 may be similarly sized and shaped to the corresponding apertures 506, 508, 510 provided in the outer cover 502 although this is not required.

The inner liner 512 may be formed of a thin layer of soft material to provide comfort to the user when the mask 500 is positioned on the face. The inner liner 512 may have a thickness in the range of 1 to 5 millimeters. In some instances, the inner liner 512 may be formed from a deformable material to allow portions of the mask 500 to conform to a profile of the user's face. It is contemplated that the inner liner 512 may be formed of a silicone, foam, or gel material. In some instances, a gel capable of delivering a sensation of coolness, at ambient temperatures, without the need for refrigeration or outside cooling could be used. Gels in combination with refrigeration or outside cooling may also be used by, for example, including a circulating system for circulation of a cooling fluid. The gel may be directly exposed to the user's face, or there may be include a thin encapsulant layer over a gel material.

Any suitable gel technology may be employed. The gel is generally a polymer composition which exhibits both liquid and solid characteristics, depending upon the particular composition, that is, the gel can range from a semi-liquid to a semi-solid. In some aspects, the gel composition may contain a three-dimensional network of cross-linked molecular chains (gels), or it may merely behave as if it contained such a network (gelloids). In some instances, the gel may be encased by a coating, membrane, or shell, or be capable of standing alone or combinations of such materials. When a coating, membrane, or shell is used, it can be a polymeric or other material capable of containing even semi-liquid gels, and providing resilient structure for the gel which permits a desired amount of deformation, while enough resiliency to return to its original shape. The gel may also include phase change materials which are useful in conveying the cooling sensation, since phase change materials, by definition absorb heat energy when changing phases.

The gel of embodiments described in this document may be any liquid-extended polymer or a gelatinous composition having a molecular weight and hardness characteristics that allow the gel to deform yet have a resilience that allows it to rebound into its original shape quickly, such as within one second or less, when the load is removed. Examples of gels used in aspects of the invention include, without limitation, oil-extended triblock copolymer compositions such as that disclosed in U.S. Pat. No. 3,485,787, U.S. Pat. No. 3,676,387, U.S. Pat. No. 3,827999, U.S. Pat. No. 4,176,240, U.S. Pat. No. 4,259,540, U.S. Pat. No. 4,351,913, U.S. Pat. No. 4,432,607, U.S. Pat. No. 4,492,428, U.S. Pat. No. 4,497,538, U.S. Pat. No. 4,509,821, U.S. Pat. No. 4,709,982, U.S. Pat. No. 4,716,183, U.S. Pat. No. 4,833,193, U.S. Pat. No. 4,942,270, U.S. Pat. No. 5,149,736, U.S. Pat. No. 5,331,036, and U.S. Pat. No. 5,994,450; and thermoplastic elastomer gelatinous compositions such as that disclosed in U.S. Pat. No. 4,369,284, U.S. Pat. No. 4,618, 213, U.S. Pat. No. 5,262,468, U.S. Pat. No. 5,508,334, U.S. Pat. No. 5,153,254, U.S. Pat. No. 5,334,646, U.S. Pat. No. 5,239,273, U.S. Pat. No. 5,475,890, and U.S. Pat. No. 5,336,708. Each of the above references is hereby incorporated by reference.

The gel can comprise any gel that is stable, nontoxic, and generally known to provide a cushioning effect while maintaining a degree of structural stability and support. In particular, the gel can comprise any gel material having a hardness and elasticity that are within a preferred range. In some embodiments, the inner liner 512 may have a hardness in the range of 1 to 65 Shore OO.

Polyurethane gels are particularly useful. Further, other gels that are resistant to hardening over time, have limited expandability, and are resistant to substance degradation (e.g., from migration of volatile agents, such as plasticizers) could also be useful as the gel in the present invention.

Examples of polyurethane gels capable of use according to the invention are disclosed in U.S. Pat. No. 6,191,216, United States Published Patent Application No. 2004/0058163 (application Ser. No. 10/618,558) and U.S. Published Patent Application No. 2004/0102573 (application Ser. No. 10/656,778), which are incorporated herein by reference. Examples of other types of gels useful according to the invention are disclosed in U.S. Pat. No. 4,404,296, U.S. Pat. No. 4,456,642, and U.S. Published Patent Application No. 2007/0061978 (application Ser. No. 11/365,473), which are incorporated herein by reference.

Any gel technology or combinations of such technologies may be used. Some gel materials may be moldable and deformable upon contact. These materials may also convey a sensation of coolness, without requiring refrigeration or external cooling. Many suitable gel materials provide a sensation of coolness when touched to the skin, and to the extent it eventually heats up during contact, the gel material returns to a cooling state when returned to ambient temperature.

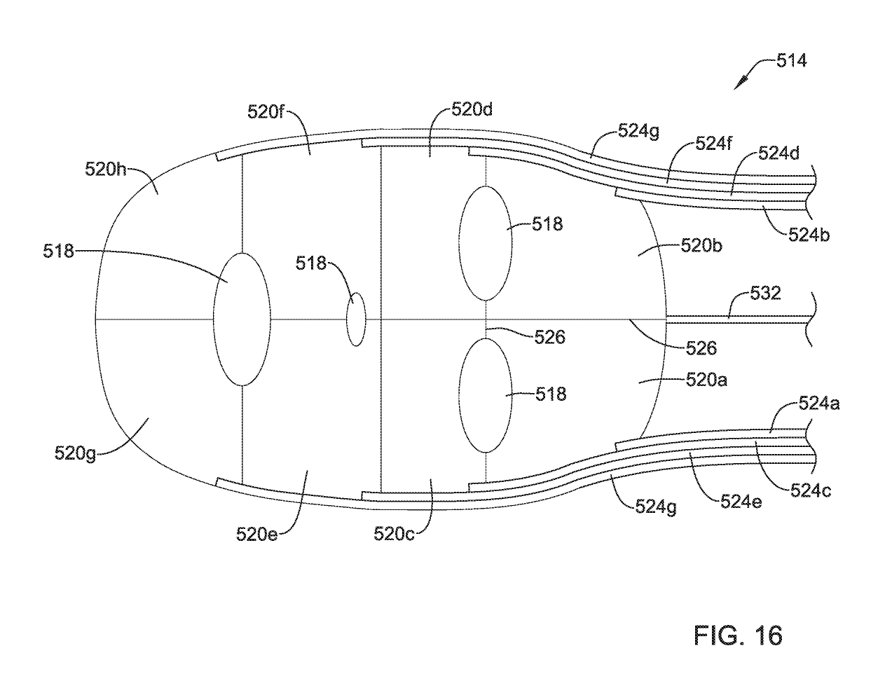

Referring additionally to FIG. 16, which illustrates a perspective bottom view of the intermediate pressure pouch 514 of FIG. 15, the intermediate pressure pouch 514 may include a plurality of individual compartments or pouches 520a-h (collectively, 520). It is contemplated that the intermediate pressure pouch 514 may be formed from two layers of polyurethane heat welded along a plurality of seams 526 to form the plurality of individual pouches 520. The compartments 520 may generally correspond to a section of the face (e.g., right forehead 520a, left forehead 520b, right under eye 520c, left under eye 520d, right cheek 520e, left cheek 520f, right jaw 520g, left jaw 520h, etc.). Each individual compartment 520 may be in fluid communication with a fluid source (e.g., air, water, etc.) 522 via a corresponding fluid line 524a-h such that each individual compartment 520 can be independently actuated or inflated (e.g., expanded) or deflated (e.g., contracted) separately or in insolation from the remaining compartments 520. The individual compartments 520 may be inflated and/or deflated to exert a pressure and/or massaging motion on a user's face, as will be described in more detail herein. In other words, pneumatic pressure may be used to provide a massaging sensation to the user's face.

The intermediate pressure pouch 514 may include one or more apertures 518. The apertures 518 may be configured to align with some or all of the apertures 506, 508, 510 provided in the outer cover 502 and/or apertures 516 provided in the inner liner 512. In some instances, the apertures 518 may be similarly sized and shaped to the corresponding apertures 506, 508, 510 provided in the outer cover 502 and/or apertures 516 provided in the inner liner 512, although this is not required.

While the mask 500 is illustrated as including eight inflatable compartments 520, it is contemplated that the mask 500 may include any number of inflatable compartments 520 desired. It is contemplated that the pressure pouch 514 may be divided into any number of inflatable sections 520 desired including, but not limited to: one, two, three, four, five, or more. In some instances, the mask 500 may include in the range of 2-16 inflatable compartments 520. In some embodiments, the inflatable compartments 520 may be symmetrically positioned. For example, there may be the same number and configuration of compartments 520 for the left side and the right side of the face. In other embodiments, the compartments 520 may be asymmetrically configured such that there are different numbers and/or configurations of compartments 520 for the left side and the right side of the face.

The inflatable compartments 520 may each be fluidly connected to a fluid source 522 and control module or control box 528 through one or more conduits 524, such as or including tubes. The conduits 524 may circulate fluid (e.g., water, air, etc.) in accordance with a control algorithm stored in a memory of the control module 528 to inflate the individual compartments 520. For example, the control module 528 may be electrically coupled to the fluid source 522 to control the amount of fluid that is used to inflate a compartment 520 to control the amount of pressure applied to the face (e.g., more fluid in a compartment will apply more pressure to the face). In some cases, the individual compartments 520 may be inflated and deflated one at a time in a predefined order and/or to a predefined pressure. In other instances, the compartments 520 may be inflated and/or in groups of two or more. Some exemplary inflation orders may include, but are not limited to, from the forehead to the chin, from the chin to the forehead, from left to right or vice versa (e.g., from a first side to a second side), from the center of the face towards the outside of the face (e.g. from inner to outer), from the outside of the face towards the center of the face, etc. In some embodiments, the user can regulate each compartment 520 individually (e.g. inflated/deflated, pressure, etc.) such that the user can customize which compartments 520 are inflated and/or the intensity (e.g., pressure) of the massaging motion.

In some embodiments, the fluid source 522 may include a heat source and/or a cooling source configured to heat and/or cool the fluid before inflating the inflatable compartments 520 to provide additional therapies. It is contemplated that the fluid may be provided at temperatures less than room temperature (e.g., refrigerated), at room temperature, or greater than room temperature (e.g., heated), as desired. The fluid source 522 and/or control module 528 may be provided with high and/or low temperature alarms such that fluid is not delivered to the mask 500 at a temperature that will injure the user.

In some embodiments, the mask 500 may also be provided with a steam and/or mist option. For example, a second fluid source 530 and control module or control box 534 may be provided. The second fluid source 530 may be fluidly coupled to the mask 500 via tubular member 532. In some cases, the tubular member 532 may deliver an ion mist and/or steam (e.g., moisture) to regions of the face (e.g. an inner surface of the mask 500), including but not limited to, near the nose, along the seams 526 of the intermediate pressure pouch 514, and/or to the whole face. It is contemplated that when the pressure pouch 514 is provided as an intermediate element (as shown in FIG. 15), the steam and/or mist may be delivered between the inner liner 512 and the face, although this is not required.

The control modules 528, 534 may further include a power cords 536, 538 configured to supply power to the control modules from a wall source (e.g. wall outlet). The fluid sources 522, 530 and/or control modules 528, 534 may also include pumps, compressors, condensers, heat exchangers, etc. configured to heat, cool, and move the fluid as desired. These additional pieces of equipment may also be powered by the power source and controlled via the control modules 528, 534. Alternatively, or additionally, power may be supplied via one or more batteries disposed within the fluid sources 522, 530 and/or control modules 528, 534. While not explicitly shown, the fluid sources 522, 530 and/or control modules 528, 534 may include an actuatable element for controlling the fluid supply to the inflatable compartments 520. In some instances, the actuatable element may be a binary on/off switch in the form of a toggle switch, pushbutton switch, selector switch, or other binary on/off switch, or plural such switches, as desired. In other instances, the actuatable element may allow for variable power to be supplied to the massaging nodes and may be in the form of a sliding switch, rotatable dial, or other variable switch as desired. In some embodiments, a plurality of actuatable elements may be provided such that the massage nodes 32 may be individually controlled. Alternatively, or additionally, the fluid sources 522, 530 and/or control modules 528, 534 may be provided with a user interface, such as, but not limited to a touch screen, that allows a user to select which compartments 520 are activated and at what intensity. In other words, the user may provide the control algorithm via the user interface.

The outer cover 502 of the mask 500 may include two or more apertures or slots 540 formed on opposite sides therein each configured to removably receive a strap 542 or other retention feature. The apertures 540 may be located on either side of the raised central region 504 adjacent to the edges of the outer cover 502. The pressure pouch 514 and/or the inner liner 512 may also include two or more apertures or slots 544, 546 generally aligned with the slots 540 of the outer cover 502. A first end of a strap 542 may be positioned and secured (releaseably or fixedly) within the slots 540, 544, 546. A second end of the strap 542 may be wrapped around the back of the head. In some instances, the second end of the strap 542 may be advanced through the slots 540, 544, 546 on the opposing side of the mask 500. The strap 542 may have an adjustable length or be formed from an elastic material to accommodate varying head sizes. In other instances, two straps 542 may be provided and the second ends of the straps may be secured to one another behind the head.

Some illustrative securing mechanisms for use with the strap(s) 542 may include, but are not limited to: hook and loop fasteners (e.g. VELCRO®), buttons, snaps, hooks, etc. Multiple securing mechanisms may be provided to allow the straps 542 to have an adjustable length. The strap(s) 542 may be configured to wrap behind a user's head to secure the mask 500 to a user's face such that the mask 500 may be used without requiring the user to hold it in place. In some embodiments, the strap(s) 542 may be secured directly to the outer cover 502, intermediate pressure pouch 514, and/or inner liner 512 of the mask 500 and slots 540, 544, 546 may be omitted.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

Those skilled in the art will recognize that the present invention may be manifested in a variety of forms other than the specific embodiments described and contemplated herein. Accordingly, departure in form and detail may be made without departing from the scope and spirit of the present invention as described in the appended claims.

What is claimed is:

1. A facial massage device, comprising:
an outer cover;
an inner liner;
an intermediate portion disposed between the outer cover and the inner liner, the intermediate portion including a plurality of individually actuatable massage elements; and
a control module configured to actuate the plurality of individually actuatable massage elements.

2. The facial massage device of claim 1, wherein the intermediate portion comprises an intermediate pressure pouch and the individually actuatable massage elements comprise a plurality of individually actuatable compartments formed in the intermediate pressure pouch and further comprising a first fluid source fluidly coupled to the plurality of individually actuatable compartments.

3. The facial massage device of claim 2, wherein the control module is configured to inflate and/or deflate the plurality of individually actuatable compartments in a predefined order.

4. The facial massage device of claim 3, wherein the predefined order is from a forehead area of the facial massage device to a chin area of the facial massage device.

5. The facial massage device of claim 3, wherein the predefined order is from an inner area of the facial massage device to an outer area of the facial massage device.

6. The facial massage device of claim 3, wherein the predefined order is from a first side of the facial massage device to a second side of facial massage device.

7. The facial massage device of claim 2, wherein the first fluid source includes a cooling mechanism for cooling a fluid before delivery to the individually actuatable compartments.

8. The facial massage device of claim 2, wherein the first fluid source includes a heating mechanism for heating a fluid before delivery to the individually actuatable compartments.

9. The facial massage device of claim 2, further comprising a second fluid source configured to deliver an ion mist adjacent to the inner liner.

10. The facial massage device of claim 2, further comprising a second fluid source configured to deliver steam adjacent to the inner liner.

11. The facial massage device of claim 2, wherein the intermediate pressure pouch comprises two layers of polyurethane heat welded along a plurality of seams to define the plurality of individually actuatable compartments.

12. The facial massage device of claim 2, wherein the control module is configured to operate a fluid delivery to the individually actuatable compartments in accordance with a user defined order.

13. A facial massage device, comprising:
an outer cover;
an inner liner;
an intermediate pressure pouch disposed between the outer cover and the inner liner, the intermediate pressure pouch comprising two layers of polyurethane heat welded along a plurality of seams to define a plurality of individually actuatable compartments;
a first fluid source fluidly coupled to the plurality of individually actuatable compartments; and
a control module in electrical communication with the first fluid source, the control module configured to control a delivery of a fluid from the first fluid source to the plurality of individually actuatable compartments.

14. The facial massage device of claim 13, wherein the control module controls the delivery of the fluid from the first fluid source to the plurality of individually actuatable compartments in accordance with a user defined control algorithm.

15. The facial massage device of claim 13, wherein the control module controls the delivery of the fluid from the first fluid source to the plurality of individually actuatable compartments in accordance with a pre-programmed control algorithm.

16. The facial massage device of claim 13, wherein the first fluid source includes a cooling mechanism for cooling the fluid before delivery to the individually actuatable compartments.

17. The facial massage device of claim 13, wherein the first fluid source includes a heating mechanism for heating the fluid before delivery to the individually actuatable compartments.

18. The facial massage device of claim 13, wherein the plurality of individually actuatable compartments includes at least eight individually actuatable compartments.

19. A facial massage device, comprising:
an outer cover;
an inner liner;
an intermediate pressure pouch disposed between the outer cover and the inner liner, the intermediate pressure pouch comprising two layers of polyurethane heat welded along a plurality of seams to define a plurality of individually actuatable compartments;
a first fluid source fluidly coupled to the plurality of individually actuatable compartments;
a control module in electrical communication with the first fluid source, the control module configured to control a delivery of a fluid from the first fluid source to the plurality of individually actuatable compartments;
a second fluid source configured to deliver moisture an inner surface of the facial massage device.

20. The facial massage device of claim 19 wherein the first fluid source includes a cooling mechanism for cooling the fluid and/or a heating mechanism for heating the fluid before delivery to the plurality of individually actuatable compartments.
